(19) United States
(12) Patent Application Publication
(10) Pub. No.: US 2025/0304202 A1
(43) Pub. Date: Oct. 2, 2025

(54) BICYCLE CANOPY

(71) Applicant: Brannon Zimmerman, Elkhart, IN (US)

(72) Inventor: Brannon Zimmerman, Elkhart, IN (US)

(21) Appl. No.: 18/618,835

(22) Filed: Mar. 27, 2024

(51) Int. Cl. B62J 17/083

(52) U.S. Cl. CPC B62J 17/083

(57) ABSTRACT

A canopy apparatus for covering a bicycle and a rider from weather elements includes a transparent cover that attaches to a front portion and a rear portion of the bicycle. The transparent cover extends over a seat of the bicycle to form a cavity in which the rider is placed when seated on the seat of the bicycle. Visual indicators make the canopy apparatus visible to others nearby, and some embodiments may include lateral sections so that the rider is encircled while riding the bicycle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to canopies and more particularly pertains to a new canopy for covering a bicycle and a rider from weather elements.

### (2) Description of Related Art Including Information Disclosed Under 37 CFR 1.97 and 1.98

The prior art discloses various canopies which protect a rider of a bicycle from inclement weather. However, the prior art fails to disclose such an apparatus which surrounds a perimeter of the user and has visual indicators which alert passersby to the bicycle and the user.

### BRIEF SUMMARY OF THE INVENTION

An embodiment of the disclosure meets the needs presented above by generally comprising a cover configured to couple and extend over a bicycle. The cover comprises a top section, a front section, and a back section, wherein the top section is coupled to and extends between a top end of the front section and an upper end of the back section. Each of the top section, the front section, and the back section comprises a transparent material. A front coupler and a back coupler are mounted to the cover. The front coupler is positioned on an inner surface of the front section at the bottom end of the front section, and the back coupler is positioned on an interior surface of the back section at the lower end of the back section. Each of the front and back couplers is configured to mount the cover to the bicycle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a canopy apparatus according to an embodiment of the disclosure.

FIG. 2 is a side view of an embodiment of the disclosure.

FIG. 3 is a front view of an embodiment of the disclosure.

FIG. 4 is a detail exploded view of a clamp of an embodiment of the disclosure.

FIG. 5 is a top in-use view of an embodiment of the disclosure.

FIG. 6 is a rear in-use view of an embodiment of the disclosure.

FIG. 7 is a perspective in-use view of an embodiment of the disclosure.

FIG. 8 is a side in-use view of an embodiment of the disclosure.

FIG. 9 is a side view of an embodiment of the disclosure.

FIG. 10 is a perspective view of an embodiment of the disclosure.

### DETAILED DESCRIPTION OF THE INVENTION

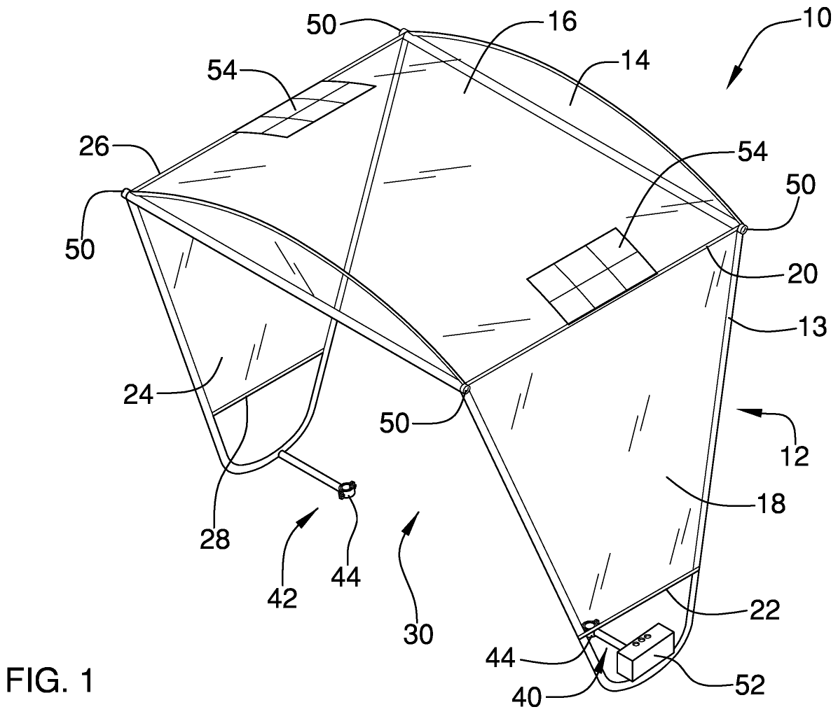

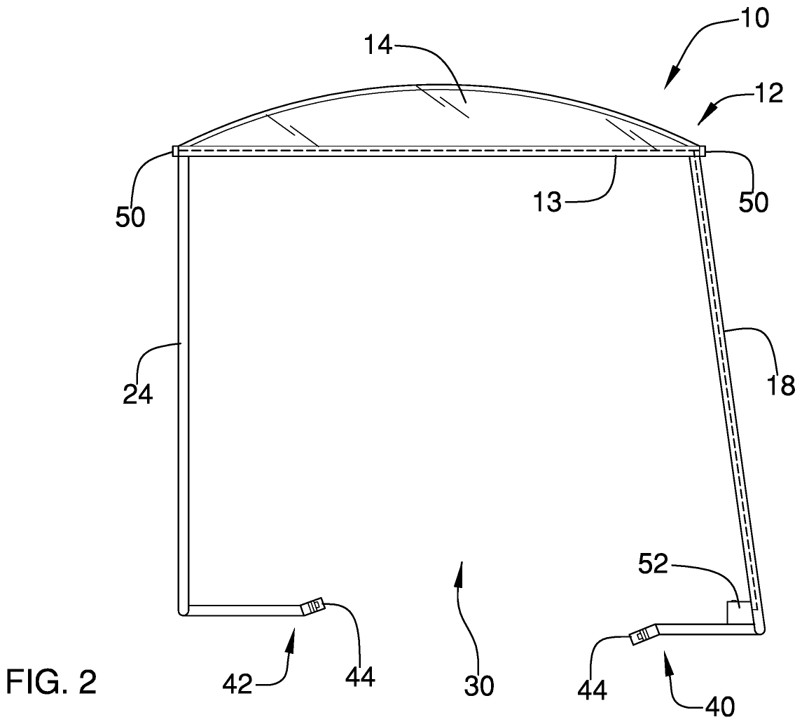

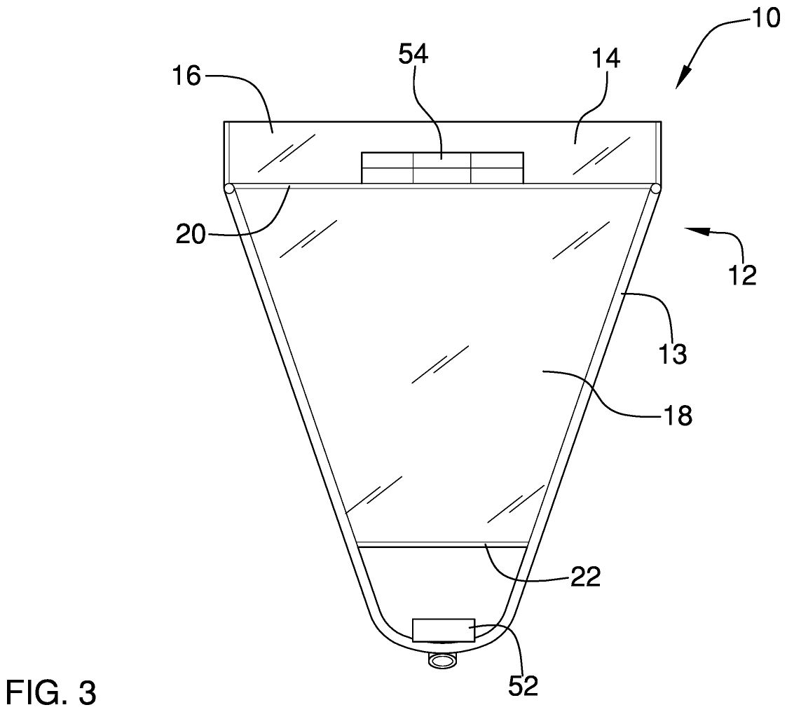

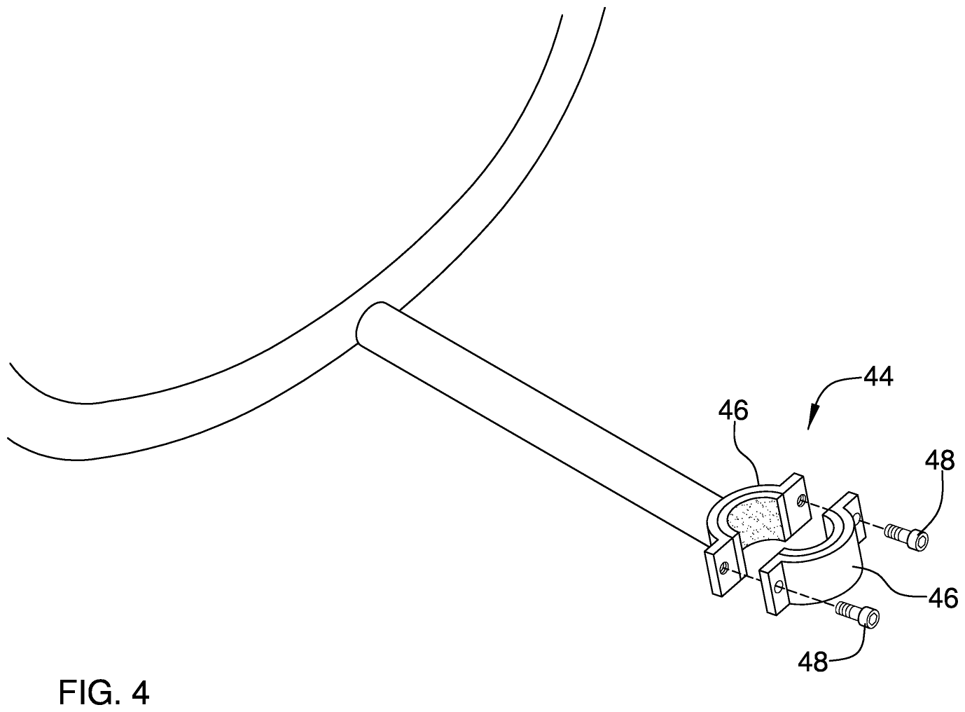

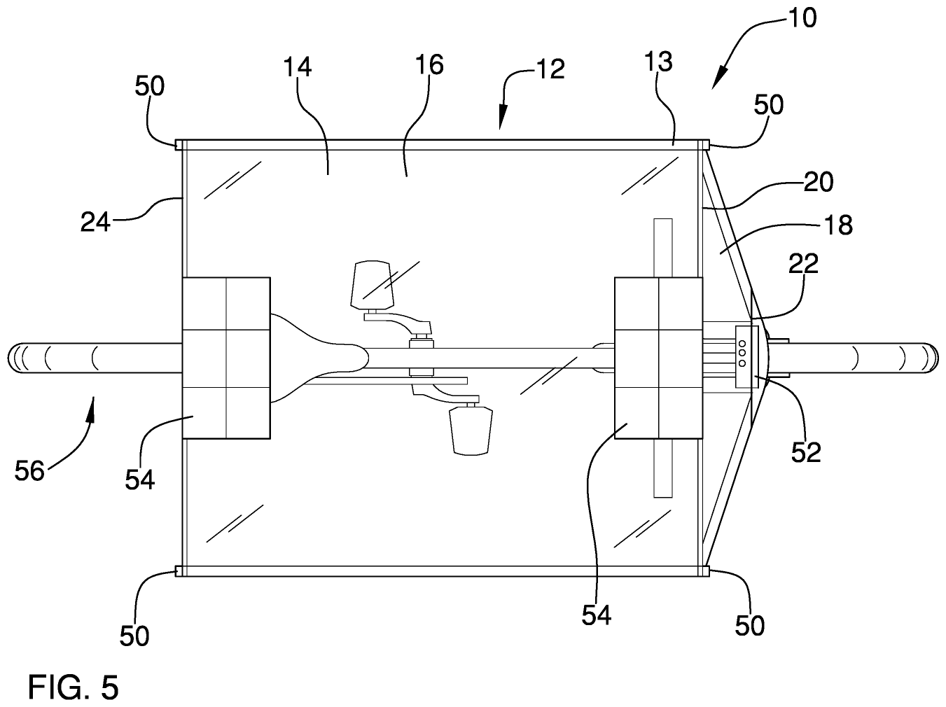

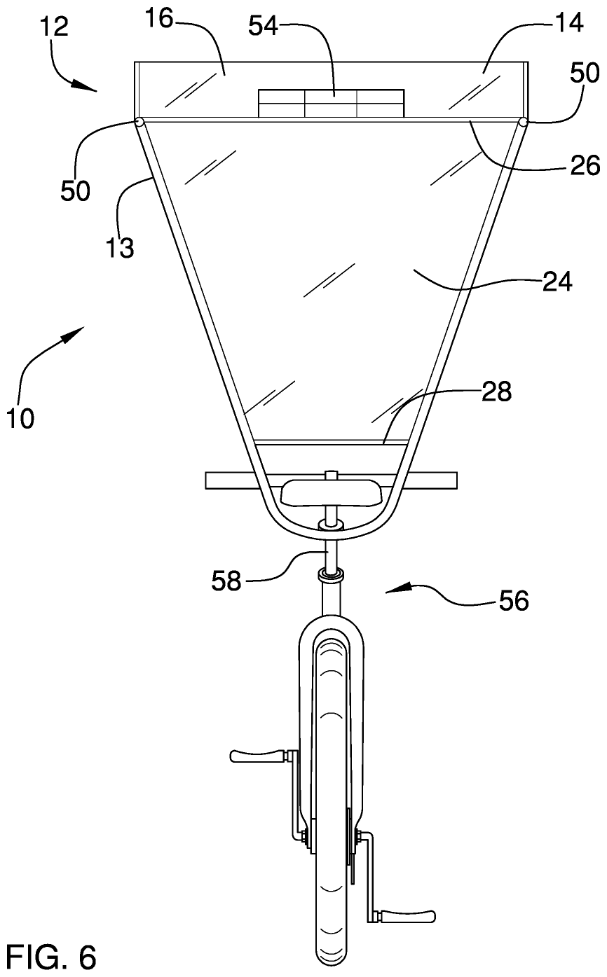

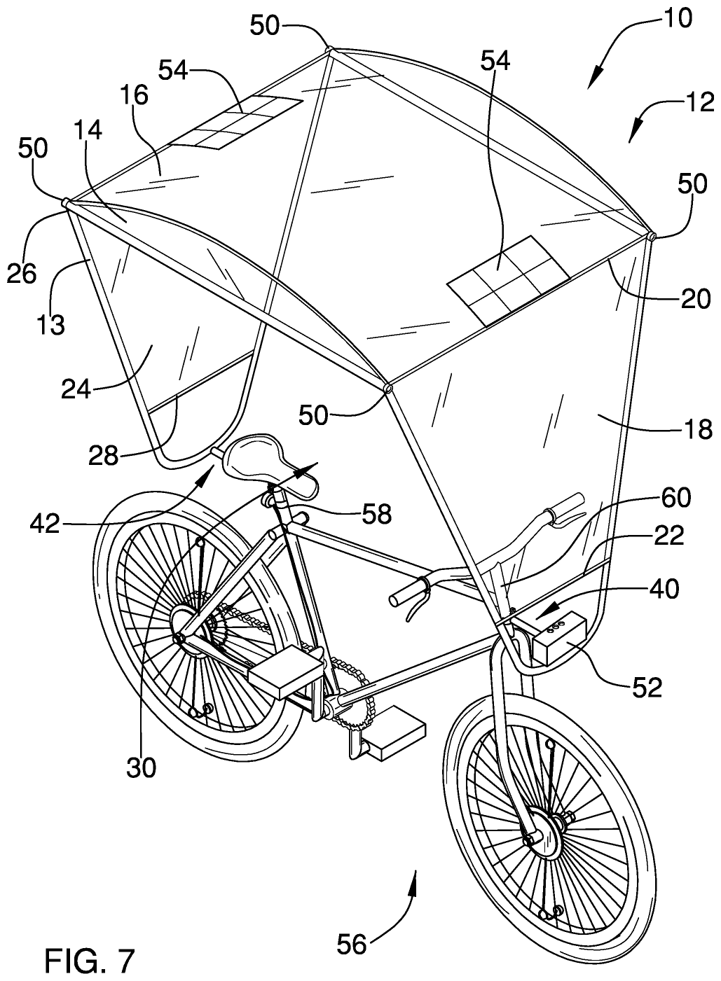

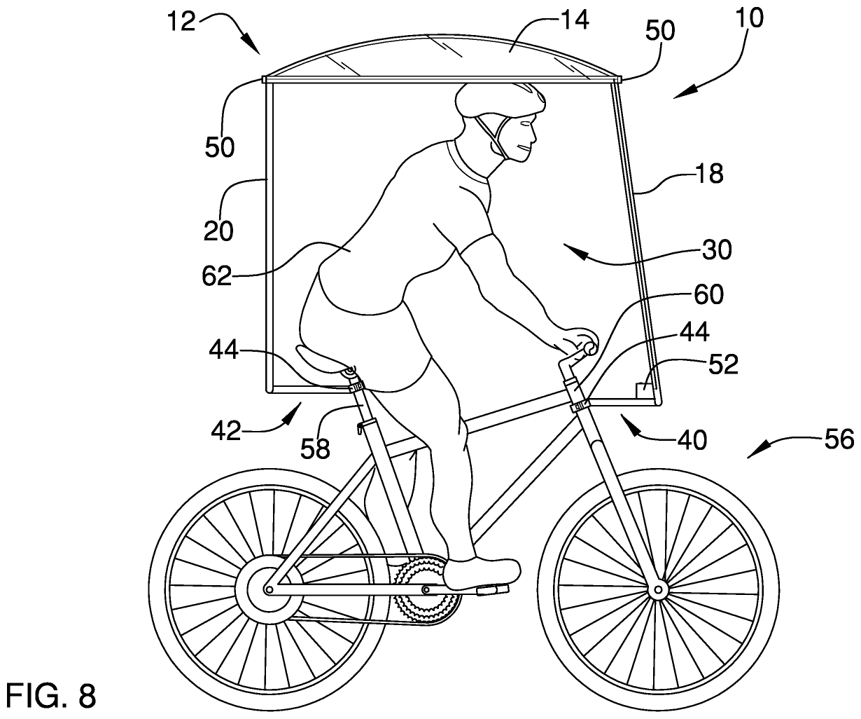

With reference now to the drawings, and in particular to FIGS. 1 through 10 thereof, a new canopy embodying the principles and concepts of an embodiment of the disclosure and generally designated by the reference numeral 10 will be described.

As best illustrated in FIGS. 1 through 10, the canopy apparatus 10 generally comprises a cover 12 configured to couple and extend over a bicycle 56. The cover 12 comprises a top section 14, a front section 18, and a back section 24, wherein the top section 14 is coupled to and extends between a top end 20 of the front section 18 and an upper end 26 of the back section 24. The cover 12 forms a cavity 30 within which a rider 62 of the bicycle 56 may sit, protected from the weather. Each of the top section 14, the front section 18, and the back section 24 comprises a transparent material such as polyurethane, acrylic, vinyl, or the like so that the rider 62 and others may see through the cover 12. The cover 12 also includes a frame 13 which is constructed of a rigid material such as metal, polyvinylchloride, wood, or the like, and which supports the top section 14, the front section 18, and the back section 24. The materials for the frame 13 and for the various sections are water impermeable and seal to each other to prevent water from entering the cavity 30 through the cover 12.

The top section 14 has a convex top surface 16 such that precipitation is directed outwardly when it lands on the top section 14. The front section 18 has a planar shape and is angled away from the back section 24 from the top end 20 to a bottom end 22 of the front section 18. The front section 18 is also angled so that it extends upwardly and backwardly relative to a ground surface during normal use. The front section 18 tapers from the top end 20 to the bottom end 22. The back section 24 has a planar shape and also tapers from the upper end 26 to a lower end 28.

A front coupler 40 and a back coupler 42 are mounted to the cover 12. The front coupler 40 is positioned on an inner surface of the front section 18 at the bottom end 22 of the front section 18, and the back coupler 42 is positioned on an interior surface of the back section 24 at the lower end 28 of the back section 24. Each of the front coupler 40 and the back coupler 42 comprises a clamp 44 with two jaws 46 that are brought toward each other via threaded fasteners 48. Various types of clamps or other suitable fasteners may be used. The front coupler 40 is configured to mount to a head tube 60 of the bicycle 56, and the back coupler 42 is configured to mount to a seat post 58 of the bicycle 56.

A plurality of visual indicators 50 is mounted to the cover 12. Each visual indicator 50 is positioned on an outer side of the canopy on an associated one of the front section 18 and the back section 24. Each visual indicator 50 of the plurality of visual indicators 50 comprises a light source, but the visual indicators 50 also may be reflectors, have bright colors, or otherwise visually draw attention of passersby so that the passersby are alerted to the presence of the bicycle 56 and the rider 62. A power supply 52 is mounted to the cover 12 and electrically coupled to the plurality of visual indicators 50. The power supply 52 comprises a battery but may comprise a capacitor or other suitable power storage. The power supply 52 powers the visual indicators 50, and a switch may be employed to alternately activate and deactivate the visual indicators 50. A pair of solar panels 54 are mounted atop the cover 12 and electrically coupled to the power supply 52 in order to charge the power supply 52.

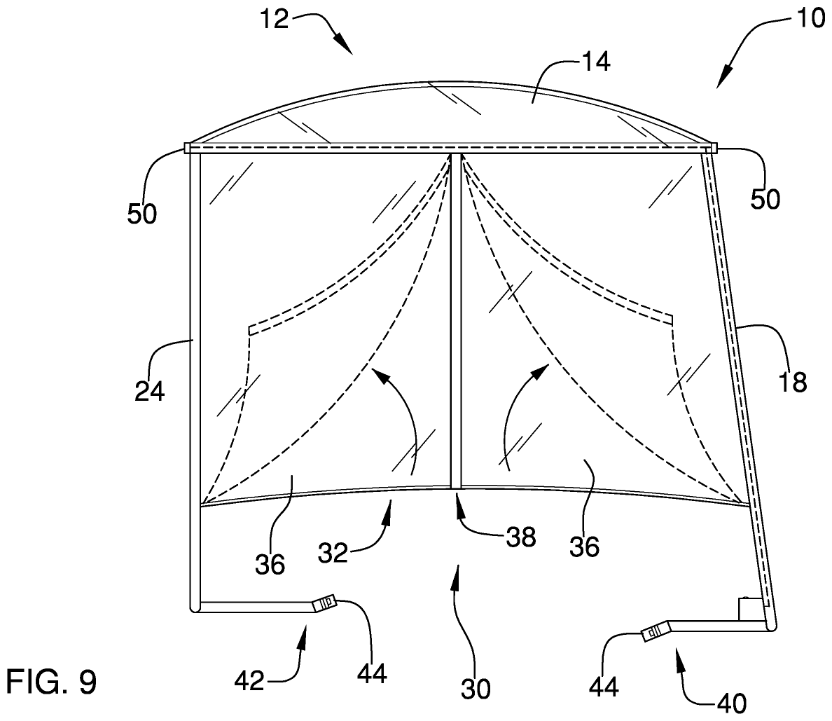

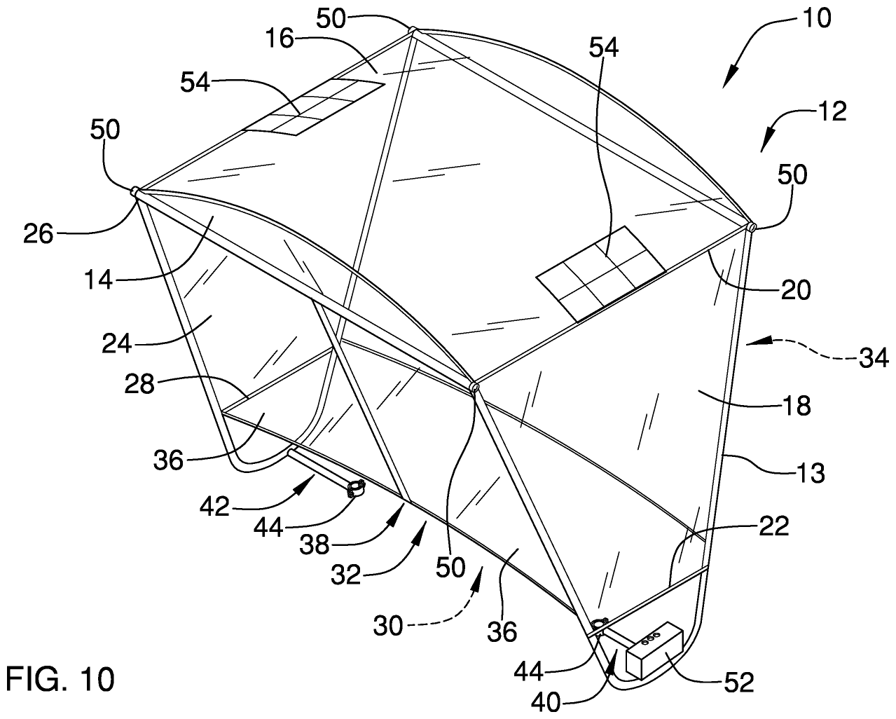

With reference to FIGS. 9 and 10, an embodiment is shown in which the cover 12 further comprises a first lateral section 32 and a second lateral section 34, each of which is coupled to and extends between the front and back sections 18, 24. The first and second lateral sections 32, 34 are spaced laterally from each other across the cavity 30. In this manner, the front section 18, the back section 24, and the first and second lateral sections 32, 34 surround a perimeter of the rider 62 while the rider 62 sits on the bicycle 56. The first lateral section 32 comprises a pair of segments 36 which are removably coupled to each other via a closure 38. The closure 38 is openable to permit passage of the rider 62 between the pair of segments 36. The closure 38 comprises a hook-and-loop fastener but may comprise a zipper, a plurality of snap buttons, or any other suitable fastener. The second lateral section 34 may also have segments 36 removably coupled via another closure 38 in some embodiments.

In use, the rider 62 rides the bicycle 56 while being protected from precipitation, wind, and other weather elements. In embodiments with the first and second lateral portions of the cover 12, the rider 62 may pass alternately in and out of the cavity 30 of the cover 12 by opening the closure 38 and passing between the pair of segments 36 of the first lateral portion.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A canopy apparatus for a bicycle, the apparatus comprising:
a cover configured to couple and extend over the bicycle, the cover comprising a top section, a front section, and a back section, the top section being coupled to and extending between a top end of the front section and an upper end of the back section, each of the top section, the front section, and the back section comprising a transparent material; and
a front coupler and a back coupler mounted to the cover, the front coupler being positioned on an inner surface of the front section at the bottom end of the front section, the back coupler being positioned on an interior surface of the back section at the lower end of the back section, each of the front and back couplers being configured to mount the cover to the bicycle.

2. The apparatus of claim 1, wherein each of the front coupler and the back coupler comprises a clamp.

3. The apparatus of claim 1, wherein the front coupler is configured to mount to a head tube of the bicycle.

4. The apparatus of claim 1, wherein the back coupler is configured to mount to a seat post of the bicycle.

5. The apparatus of claim 1, wherein the cover is water impermeable.

6. The apparatus of claim 1, wherein the top section has a convex top surface.

7. The apparatus of claim 1, wherein the front section has a planar shape, the front section being angled away from the back section from the top end to a bottom end of the front section.

8. The apparatus of claim 1, wherein the front section tapers from the top end to the bottom end.

9. The apparatus of claim 1, wherein the back section has a planar shape.

10. The apparatus of claim 1, wherein the back section tapers from the upper end to a lower end of the back section.

11. The apparatus of claim 1, wherein the cover further comprises a first lateral section and a second lateral section, the first and second lateral sections being coupled to and extending between the front and back sections, the first and second lateral sections being spaced laterally from each other.

12. The apparatus of claim 11, wherein the first lateral section comprises a pair of segments removably coupled to each other via a closure, the closure being openable to permit passage of a person between the pair of segments.

13. The apparatus of claim 12, wherein the closure comprises a hook-and-loop fastener.

14. The apparatus of claim 1, further comprising a plurality of visual indicators mounted to the cover, each visual indicator of the plurality of visual indicators being positioned on an outer side of the canopy.

15. The apparatus of claim 14, wherein each visual indicator of the plurality of visual indicators being positioned on an associated one of the front section and the back section.

16. The apparatus of claim 14, wherein each visual indicator of the plurality of visual indicators comprises a light source, further comprising a power supply mounted to the cover and electrically coupled to the plurality of visual indicators.

17. The apparatus of claim 16, wherein the power supply comprises a battery.

18. The apparatus of claim 16, further comprising a solar panel mounted atop the cover and electrically coupled to the power supply.

19. A canopy apparatus for a bicycle, the apparatus comprising:
a cover configured to couple and extend over the bicycle, the cover comprising a top section, a front section, and a back section, the top section being coupled to and extending between a top end of the front section and an upper end of the back section, each of the top section, the front section, and the back section comprising a transparent material, the cover being water impermeable, the top section having a convex top surface, the front section having a planar shape, the front section being angled away from the back section from the top end to a bottom end of the front section, the front section tapering from the top end to the bottom end, the back section having a planar shape, the back section tapering from the upper end to a lower end of the back section, the cover further comprising a first lateral section and a second lateral section, the first and second lateral sections being coupled to and extending between the front and back sections, the first and second lateral sections being spaced laterally from each other, the first lateral section comprising a pair of segments removably coupled to each other via a closure, the closure being openable to permit passage of a person between the pair of segments, the closure comprising a hook-and-loop fastener;
a front coupler and a back coupler mounted to the cover, the front coupler being positioned on an inner surface of the front section at the bottom end of the front section, the back coupler being positioned on an interior surface of the back section at the lower end of the back section, each of the front coupler and the back coupler comprising a clamp, the front coupler being configured to mount to a head tube of the bicycle, the back coupler being configured to mount to a seat post of the bicycle;
a plurality of visual indicators mounted to the cover, each visual indicator of the plurality of visual indicators being positioned on an outer side of the canopy, each visual indicator of the plurality of visual indicators being positioned on an associated one of the front section and the back section, each visual indicator of the plurality of visual indicators comprising a light source;
a power supply mounted to the cover and electrically coupled to the plurality of visual indicators, the power supply comprising a battery; and
a solar panel mounted atop the cover and electrically coupled to the power supply.
